(19) United States
(12) Patent Application Publication
(10) Pub. No.: US 2026/0105550 A1
(43) Pub. Date: Apr. 16, 2026

(54) SYSTEM AND METHOD FOR AI-ASSISTED PATENT OFFICE ACTION RESPONSE GENERATION

(71) Applicant: Solve Intelligence, Inc., London (GB)

(72) Inventors: Sanjeevan Ahilan, London (GB); Angus Parsonson, London (GB); Chris Parsonson, London (GB); Justin Doop, London (GB)

(21) Appl. No.: 19/359,400

(22) Filed: Oct. 15, 2025

Related U.S. Application Data
(60) Provisional application No. 63/708,085, filed on Oct. 16, 2024.

(51) Int. Cl. G06Q 50/18

(52) U.S. Cl. CPC G06Q 50/18

(57) ABSTRACT

A system for generating responses to patent Office actions includes a server configured to retrieve an Office action from a patent Office database, an artificial intelligence (AI) module configured to analyze the Office action and generate response strategies, a user interface configured to display the generated response strategies and an Office action response template, and a processor configured to generate text for sections of the Office action response based on user selections of the response strategies. The AI module extracts rejections and objections from the Office action and generates response strategies based on the extracted information. The system retrieves prior art documents cited in the Office action from a prior art database and incorporates relevant information into the generated response strategies. The user interface displays relevant law citations related to the rejections, which are incorporated into the generated text for sections of the Office action response.

### CROSS REFERENCE TO RELATED APPLICATIONS

This application claims the benefit of U.S. Application No. 63/708,085, filed on Oct. 16, 2024, and entitled “SYSTEM AND METHOD FOR AI-ASSISTED PATENT OFFICE ACTION RESPONSE GENERATION,” which is incorporated by reference herein in its entirety.

### REFERENCE REGARDING FEDERALLY SPONSORED RESEARCH OR DEVELOPMENT

Not applicable

### SEQUENCE LISTING

Not applicable

### BACKGROUND

### 1. Field of the Invention

The present disclosure relates to systems and methods for generating responses to patent Office actions, and more particularly to an AI-assisted system and method for analyzing Office actions, generating response strategies, and drafting Office action responses.

### 2. Description of the Background

Patent prosecution is a complex and time-consuming process that involves responding to Office actions issued by patent offices such as the United States Patent and Trademark Office (USPTO). These Office actions typically contain rejections and objections to patent applications based on various grounds, including lack of novelty, obviousness, indefiniteness, and formal matters. Responding to these Office actions requires careful analysis of the rejections, thorough review of cited prior art, and crafting persuasive arguments to overcome the examiner's objections.

Traditionally, patent attorneys and agents have manually drafted responses to Office actions, which can be a labor-intensive and time-consuming task. This process often involves reviewing extensive documentation, including the patent application, Office action, cited prior art, and relevant case law. The attorney must then formulate appropriate strategies to address each rejection and draft a comprehensive response that addresses all issues raised by the examiner.

The increasing complexity of technology and the growing volume of patent applications have led to a need for more efficient methods of responding to Office actions. Additionally, the vast amount of available prior art and legal precedents make it challenging for attorneys to stay up-to-date with all relevant information that could be useful in crafting effective responses.

In recent years, there has been a growing interest in leveraging artificial intelligence (AI) and machine learning technologies to assist in various aspects of the legal profession, including patent prosecution. These technologies have shown promise in automating certain tasks, analyzing large volumes of data, and providing insights that can aid in decision-making processes.

However, existing AI-assisted tools in the patent prosecution field often suffer from limitations such as lack of context-awareness, inability to generate human-like responses, and difficulty in adapting to the specific requirements of different patent offices and examiners. Furthermore, many current systems struggle to effectively integrate AI-generated content with human expertise and judgment, which are crucial in the nuanced field of patent law.

There remains a need for improved systems and methods that can effectively leverage AI technologies to assist patent practitioners in analyzing Office actions, generating response strategies, and drafting high-quality Office action responses while maintaining the necessary level of human oversight and expertise.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for generating responses to patent Office actions is provided. The system includes a server configured to retrieve an Office action from a patent Office database. The system also includes an artificial intelligence (AI) module configured to analyze the Office action and generate response strategies. The system further includes a user interface configured to display the generated response strategies and an Office action response template. Additionally, the system includes a processor configured to generate text for sections of the Office action response based on user selections of the response strategies.

According to other aspects of the present disclosure, the system may include one or more of the following features. The AI module may be further configured to extract rejections and objections from the Office action. The AI module may be configured to generate the response strategies based on the extracted rejections and objections. The system may further comprise a prior art database, wherein the server may be configured to retrieve prior art documents cited in the Office action from the prior art database. The AI module may be configured to analyze the retrieved prior art documents and incorporate relevant information into the generated response strategies. The user interface may be configured to display relevant law citations related to the rejections in the Office action. The processor may be configured to incorporate the relevant law citations into the generated text for sections of the Office action response.

According to another aspect of the present disclosure, a method for generating responses to patent Office actions is provided. The method includes retrieving an Office action from a patent Office database. The method also includes analyzing the Office action using an artificial intelligence (AI) module to generate response strategies. The method further includes displaying the generated response strategies and an Office action response template on a user interface. Additionally, the method includes generating text for sections of the Office action response based on user selections of the response strategies.

According to other aspects of the present disclosure, the method may include one or more of the following features. The method may further comprise extracting rejections and objections from the Office action using the AI module. Generating the response strategies may be based on the extracted rejections and objections. The method may further comprise retrieving prior art documents cited in the Office action from a prior art database. The method may further comprise analyzing the retrieved prior art documents using the AI module and incorporating relevant information into the generated response strategies. The method may further comprise displaying relevant law citations related to the rejections in the Office action on the user interface. Generating text for sections of the Office action response may include incorporating the relevant law citations into the generated text.

According to another aspect of the present disclosure, a non-transitory computer-readable medium storing instructions is provided. When executed by a processor, the instructions cause the processor to perform operations for generating responses to patent Office actions. The operations include retrieving an Office action from a patent office database. The operations also include analyzing the Office action using an artificial intelligence (AI) module to generate response strategies. The operations further include displaying the generated response strategies and an Office action response template on a user interface. Additionally, the operations include generating text for sections of the Office action response based on user selections of the response strategies.

According to other aspects of the present disclosure, the operations may include one or more of the following features. The operations may further comprise extracting rejections and objections from the Office action using the AI module. Generating the response strategies may be based on the extracted rejections and objections. The operations may further comprise retrieving prior art documents cited in the Office action from a prior art database. The operations may further comprise analyzing the retrieved prior art documents using the AI module and incorporating relevant information into the generated response strategies. The operations may further comprise displaying relevant law citations related to the rejections in the Office action on the user interface. Generating text for sections of the Office action response may include incorporating the relevant law citations into the generated text.

According to another aspect of the present disclosure, a method for improving an efficiency and a performance of a system for drafting a response to a patent Office action by utilizing an artificial intelligence (AI) machine is provided. The method includes inputting, through a user interface, an application number associated with the patent Office action. The method also includes loading, through a server, the patent Office action and one or more documents related to the application number. The method further includes generating, using an AI machine, response strategies for responding to one or more rejections or objections in the patent Office action. Additionally, the method includes receiving, through the user interface, generated text affiliated with a response to the one or more rejections or objections in the patent Office action.

According to another aspect of the present disclosure, a system with improved efficiency and performance in drafting a response to a patent Office action by utilizing an artificial intelligence (AI) machine is provided. The system includes a client device configured to display a user interface. The system also includes a server communicatively coupled to the client device. The system further includes a large language model (LLM) server communicatively coupled to the server. The server is configured to receive a placeholder identified from the client device, generate a prompt, communicate the prompt to the LLM server, receive generated text from the LLM server, and transmit the generated text to the client device and display the generated text on the user interface.

According to another aspect of the present disclosure, a non-transitory computer-readable medium storing instructions is provided. When executed by a processor, the instructions cause the processor to perform operations for improving an efficiency and a performance of a system for drafting a response to an Office action. The operations include displaying one or more placeholders associated with sections of an Office action response on a user interface. The operations also include receiving user input selecting a placeholder. The operations further include transmitting a request to draft the selected section, the request including a placeholder identifier. Additionally, the operations include receiving generated text for the selected section and displaying the generated text through the user interface.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1 illustrates a flowchart for an automated method of responding to patent Office actions, according to aspects of the present disclosure;

FIG. 2 depicts a sequence diagram of interactions between various components in a patent response system, in accordance with example embodiments;

FIG. 3 shows a user interface for managing patent Office action responses, according to an embodiment;

FIG. 4 illustrates the user interface of FIG. 3 displaying response strategies, according to aspects of the present disclosure;

FIG. 5 depicts the user interface of FIG. 3 showing detailed response strategies for a specific rejection, in accordance with example embodiments;

FIG. 6 illustrates the user interface of FIG. 3 displaying further details of a selected response strategy, according to an embodiment;

FIG. 7 shows the user interface of FIG. 3 with a placeholder for generating text, according to aspects of the present disclosure; and

FIG. 8 depicts the user interface of FIG. 3 displaying generated text and user interaction options, in accordance with example embodiments.

### DETAILED DESCRIPTION OF THE DRAWINGS

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure provides a system and method for managing and responding to patent Office actions. The system and method leverage artificial intelligence (AI) technologies to automate and streamline various aspects of the patent prosecution process. Key components of the system include a server configured to retrieve Office actions from a patent Office database, an AI module for analyzing Office actions and generating response strategies, a user interface for displaying the generated response strategies and an Office action response template, and a processor for generating text for sections of the Office action response based on user selections of the response strategies.

In some embodiments, the AI module may be configured to extract rejections and objections from the Office action and generate response strategies based on the extracted information. The system may also include a prior art database, from which the server can retrieve prior art documents cited in the Office action. The AI module may analyze the retrieved prior art documents and incorporate relevant information into the generated response strategies.

In certain embodiments, the user interface may display relevant law citations related to the rejections in the Office action. The processor may incorporate the relevant law citations into the generated text for sections of the Office action response. The system and method disclosed herein provide a comprehensive and efficient approach to managing patent Office actions, potentially reducing the time and effort required to respond to such actions while maintaining a high level of accuracy and quality in the responses generated.

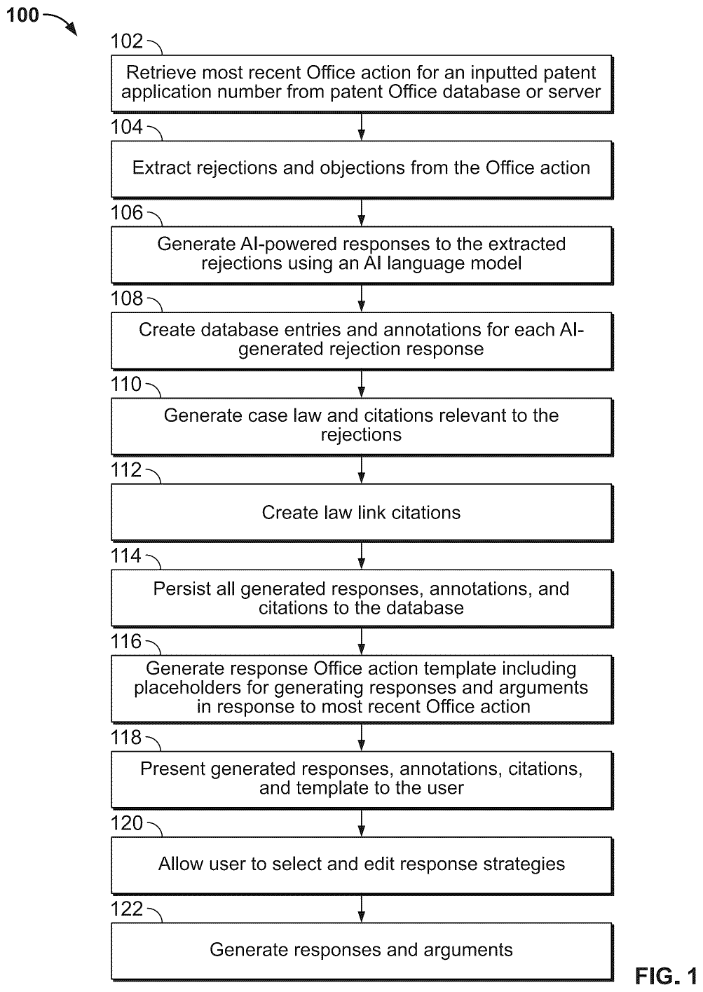

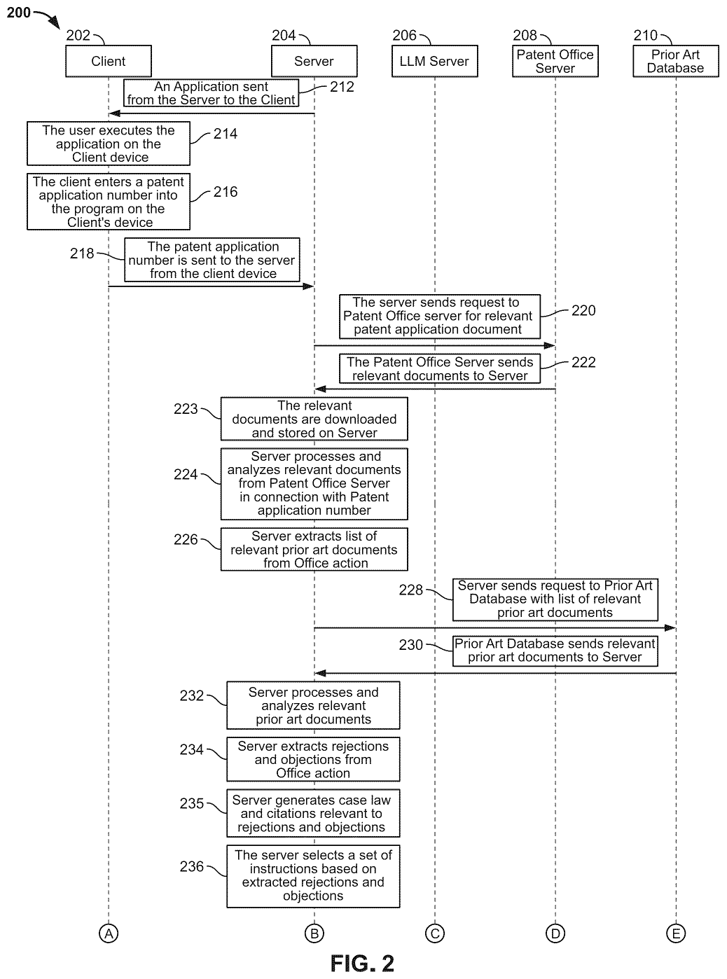

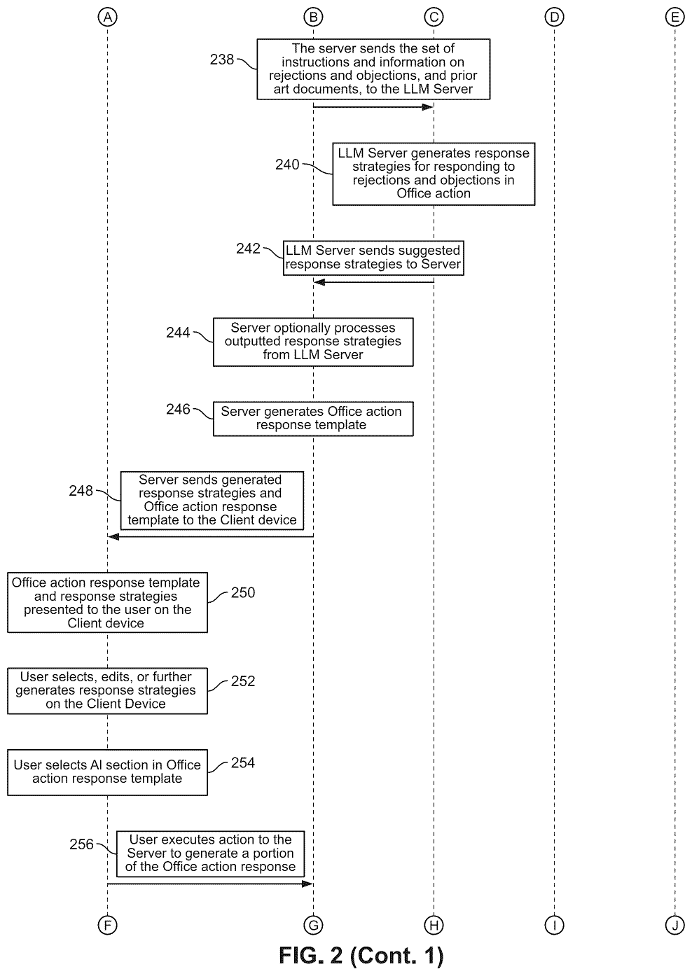

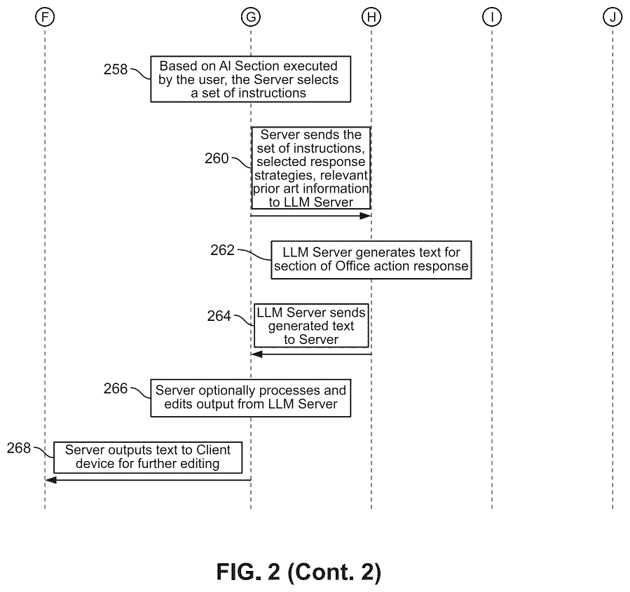

Referring to FIG. 1, a flowchart illustrates an automated method 100 for responding to patent Office actions. The method 100 begins at step 102, where a server (e.g., a server 204 shown in FIG. 2) retrieves the most recent Office action for an inputted patent application number from a patent Office database or server (e.g., a patent Office server 208 shown in FIG. 2). The server (e.g., the server 204 shown in FIG. 2) may be configured to communicate with the patent Office server (e.g., the server 208 shown in FIG. 2) to request and receive Office actions associated with a given patent application number. In some cases, the server (e.g., the server 204 shown in FIG. 2) may retrieve the Office action by accessing a database or server that stores Office actions issued by a patent Office, such as the United States Patent and Trademark Office (USPTO) or the European Patent Office (EPO).

In step 104, the method 100 involves extracting rejections and objections from the retrieved Office action. This extraction may be performed by an AI module, which may be configured to analyze the content of the Office action and identify sections or passages that correspond to rejections or objections. The AI module may use natural language processing techniques, pattern recognition, or other AI techniques to perform this analysis and extraction.

The method 100 may then proceeds to step 106, where AI-powered responses to the extracted rejections may be generated. The AI module may generate the AI-powered responses based on a variety of factors, including the nature of the rejections, the content of the Office action, and potentially other information related to the patent application. The AI module may use machine learning models, such as large language models (LLMs), to generate the AI-powered responses.

Following this, in step 108, database entries and annotations are created for each AI-generated rejection response. The server (e.g., the server 204 shown in FIG. 2) may create the database entries and annotations in a database, which may store information about the Office action, the rejections, the AI-generated responses, and potentially other related information. The annotations may provide additional context or references for the AI-generated responses.

Next, step 110 involves generating case law or law citations relevant to the rejections. The AI module may identify relevant case law or legal principles that may be cited in the responses to the rejections. The law citations may be generated based on the content of the rejections, the AI-generated responses, and potentially other factors.

The method 100 then moves to step 112, where law link creations may be made. This may involve creating hyperlinks or other types of links that connect citations in the responses to corresponding case law or legal principles. In some aspects, the server 204 (see FIG. 2) may manage the law link creations. The process may include analyzing the generated responses and identifying relevant legal references. In some cases, existing links may be updated or removed, and new links may be added based on the current context of the response. This step may assist in maintaining the accuracy and relevance of legal citations within the Office action response. As the AI module analyzes the Office action and generates response strategies, it may identify new relevant case law or legal principles that were not previously linked. Conversely, some existing links may become obsolete or less relevant in the context of the current response.

The creation of hyperlinks or other types of links serves multiple purposes. First, it provides easy access for the user to review the full text of cited documents, cases, or legal principles, enhancing their understanding of the legal basis for the arguments. Second, it creates a structured network of legal references within the response, which can be valuable for future reference or if the application proceeds to appeal. Finally, the links can facilitate the examiner's review of the response by providing quick access to the cited legal authorities.

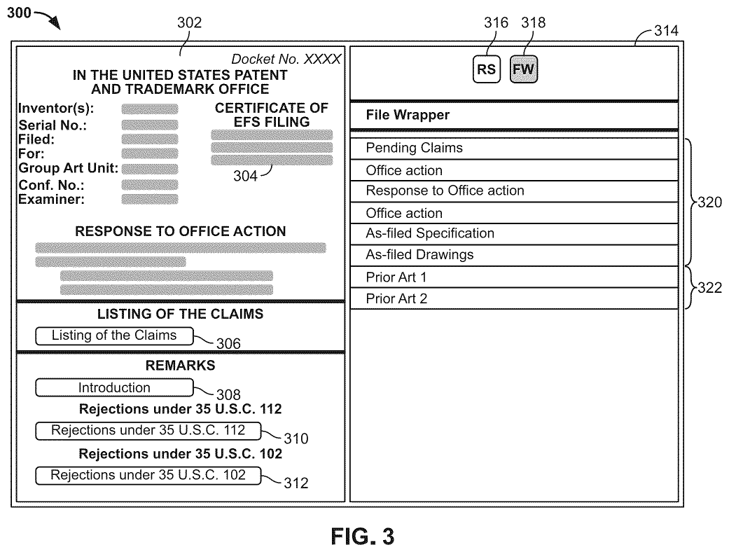

In step 114, all generated responses, annotations, and citations are persisted to the database. The server (e.g., the server 204 shown in FIG. 2) may update the database with this information, which may be used in later stages of the patent prosecution process or for other purposes. The method 100 continues with step 116, where a response office action template (or Office action response template) 302 is generated as shown in FIG. 3, including placeholders for generating responses and arguments in response to the most recent Office action. The server 204 (see FIG. 2) may generate this template, which may provide a structured format for the responses to the Office action.

Step 118 involves presenting the generated responses, annotations, citations, and template to the user on a client device 202 (see FIG. 2). The server 204 (see FIG. 2) may transmit this information to the client device 202, where it may be displayed in a user interface 300.

The method 100 then proceeds to step 120, where the user is allowed to select and edit response strategies. For example, a user may interact with a user interface, such as a user interface 300 (see FIG. 3), on a client device, such as the client device 202 (see FIG. 2), to select and edit the AI-generated responses, the annotations, the citations, and potentially other elements of the response to the Office action.

Finally, in step 122, the method 100 generates responses and arguments based on the user's selections and edits. The server (e.g., the server 204 shown in FIG. 2) may generate this text, which may be included in the response to the Office action. The generated text may be based on the user's selections and edits, the AI-generated responses, the annotations, the citations, and potentially other factors. The generated text may be formatted according to the Office action response template (e.g., the Office action template 302 shown in FIG. 3), and may be transmitted to the patent Office as a response to the Office action.

In some embodiments, the method 100 may be implemented as a set of instructions stored on a non-transitory computer-readable medium. When executed by a processor, the set of instructions may cause the processor to perform operations for generating responses to Office actions. The non-transitory computer-readable medium may include, but is not limited to, a hard disk drive, solid-state drive, flash memory, or other suitable storage device.

The instructions stored on the non-transitory computer-readable medium may correspond to the steps of the method 100. For example, the instructions may cause the processor to retrieve an Office action from a patent Office database, extract rejections and objections from the Office action using an AI module, generate AI-powered responses to the extracted rejections, create database entries and annotations for each AI-generated rejection response, and perform other operations as described in the method 100. By implementing the method 100 as executable instructions on a non-transitory computer-readable medium, the system may provide a flexible and efficient means of automating the process of responding to patent Office actions across various computing platforms and environments.

Referring to FIG. 2, a sequence diagram 200 illustrates the interactions between various components of the system for generating responses to patent Office actions. The sequence diagram 200 includes the client device 202, the server 204, a large language model (LLM) server 206, the patent Office server 208, and a prior art database 210.

In step 212, the server 204 sends an application to the client. The application may be a software application configured to facilitate the management and response of patent Office actions. The application may include a user interface 300 (see FIG. 3) that allows a user to input a patent application number, select and edit response strategies, and generate responses to Office actions.

In step 214, a user executes the application on the client device 202. The client device 202 may be any computing device capable of running the application, such as a personal computer, a laptop, a tablet, or a smartphone. In step 216, the client enters a patent application number into the program on the client device 202. The patent application number may be associated with a patent application for which an Office action has been issued by a patent Office. Next, in step 218, the patent application number is sent to the server 204 from the client device 202. The server 204 may be configured to receive the patent application number and use it to retrieve the corresponding Office action and related documents.

In step 220, the server 204 sends a request to the patent Office server 208 for the relevant patent application document. The patent Office server 208 may be a server or database maintained by a patent Office, such as the USPTO or EPO, that stores Office actions and other documents related to patent applications.

In some embodiments, the connection between the server 204 and the patent Office server 208 may be implemented using an Application Programming Interface (API). The API may provide a standardized set of protocols and tools for communication between the server 204 and the patent Office server 208, allowing for efficient and secure data exchange. The API may enable the server 204 to send requests for specific patent application documents, Office actions, or other relevant information to the patent Office server 208. In response, the patent Office server 208 may use the API to transmit the requested data back to the server 204 in a structured format that can be easily processed and analyzed.

In some cases, the API may support various types of queries and data retrieval operations. For example, the server 204 may use the API to search for patent applications based on application numbers, retrieve Office actions associated with specific applications, or access updated status information for pending applications. The API may also incorporate authentication and authorization mechanisms to ensure that only authorized systems and users can access the patent Office data. This may include the use of API keys, OAuth tokens, or other secure authentication methods to verify the identity and permissions of the requesting server.

In some implementations, the API may support real-time data synchronization between the server 204 and the patent Office server 208. This may allow the system to automatically retrieve updates or new Office actions as soon as they become available, ensuring that the information presented to users is always current and accurate.

With continued reference to FIG. 2, in step 222, the patent Office server 208 sends the relevant documents to the server 204, and the relevant documents are downloaded and stored on the server 204. The relevant documents may include the Office action, the patent application, and any other documents related to the patent application.

In some aspects, the server 204 may implement a document refinement process to ensure that only the most relevant documents are downloaded and stored. This refinement process may involve filtering the documents based on predefined criteria, such as document type, document code, date range, or specific keywords related to the patent application. The server 204 may also use machine learning algorithms to analyze the content of the documents and prioritize those that are most likely to be relevant to the current Office action response. By refining the downloaded documents, the system may reduce storage requirements and improve processing efficiency in subsequent steps.

In step 224, the server 204 processes and analyzes the relevant documents from the patent Office server 208 in connection with the patent application number. The server 204 may use various techniques to process and analyze the documents, such as text extraction, natural language processing, and machine learning algorithms. The server 204 may also use an AI module to analyze the Office action and generate response strategies.

In step 226, the server 204 extracts a list of relevant prior art documents from the Office action. The server 204 may use the AI module to identify references to prior art documents in the Office action. The list of relevant prior art documents may include patent publications, non-patent literature, or any other documents that are cited in the Office action as prior art.

In step 228, the server 204 sends a request to the prior art database 210 with the list of relevant prior art documents. The prior art database 210 may be a database or server that stores prior art documents. The server 204 may be configured to communicate with the prior art database 210 to retrieve the relevant prior art documents.

In step 230, the prior art database 210 sends the relevant prior art documents to the server 204. The server 204 may download and store the prior art documents for further processing and analysis.

In step 232, the server 204 processes and analyzes the relevant prior art documents. The server 204 may use the AI module to analyze the content of the prior art documents and incorporate relevant information into the generated response strategies. The server 204 may also use the AI module to extract rejections and objections from the Office action and generate response strategies based on the extracted information.

In step 234, the server 204 extracts rejections and objections from the Office action. This extraction may be performed by an AI module, which may be configured to analyze the content of the Office action and identify sections or passages that correspond to rejections or objections. The AI module may use natural language processing techniques, pattern recognition, or other AI techniques to perform this analysis and extraction.

In step 236, the server 204 selects a set of instructions based on the extracted rejections and objections. The set of instructions may include guidelines or rules for generating responses to the rejections and objections. The server 204 may select the set of instructions based on various factors, such as the nature of the rejections and objections, the content of the Office action, and potentially other information related to the patent application.

In particular embodiments, the server 204 may select the set of instructions based on the specific types of rejections and/or objections present in the Office action. This tailored approach may allow for more targeted and effective response strategies. For example, if the Office action includes a rejection under 35 U.S.C. 102, the server 204 may select a set of instructions specifically designed to address anticipation rejections. The set of instructions may include typical response strategies such as arguing that the cited reference fails to disclose one or more claim elements, or proposing claim amendments to distinguish the invention from the prior art.

On the other hand, if the Office action contains a rejection under 35 U.S.C. 112(a), the server 204 may select a different set of instructions tailored to address written description or enablement issues. The set of instructions may guide the AI module to generate response strategies that focus on identifying support for the claimed subject matter in the specification or arguing that the level of detail provided is sufficient for one skilled in the art to make and use the invention.

In some cases, the Office action may include multiple types of rejections and objections. The server 204 may then select multiple sets of instructions, each corresponding to a different type of rejection or objection. The AI module may use the sets of instructions in combination to generate a comprehensive response strategy that addresses all issues raised in the Office action.

The server 204 may also consider the specific details of each rejection when selecting the set of instructions. For instance, in the case of a 35 U.S.C. 103 rejection, the server 204 may select different sets of instructions based on whether the rejection relies on a single reference or a combination of references. The selected instructions may guide the AI module to generate strategies that focus on arguing against the combination of references or the motivation to combine, as appropriate.

In some implementations, the server 204 may use machine learning techniques to refine and improve the selection of instruction sets over time. The system may analyze the success rates of different response strategies for various types of rejections and adjust the instruction sets accordingly. This adaptive approach may allow the system to continuously improve its ability to generate effective response strategies.

Still referencing FIG. 2, in step 238, the server 204 sends the set of instructions, along with information on rejections and objections, and prior art documents, to the LLM server 206. The LLM server 206 may be a separate server or system that hosts a large language model (LLM), which is a type of AI model capable of generating human-like text. The LLM server 206 may use the set of instructions and the provided information to generate response strategies for responding to the rejections and objections.

In step 240, the LLM server 206 generates response strategies for responding to the rejections and objections in the Office action. The LLM server 206 may use the set of instructions and the provided information to generate the response strategies. The response strategies may include proposed arguments, amendments, or other responses to the rejections and objections.

In step 242, the LLM server 206 sends the suggested response strategies to the server 204. The server 204 may receive the response strategies and optionally process them further. For example, the server 204 may filter, rank, or otherwise organize the response strategies based on various criteria.

In step 244, the server 204 optionally processes the outputted response strategies from the LLM server 206. The server 204 may perform various operations on the response strategies, such as filtering, ranking, or organizing the strategies based on various criteria. The server 204 may also incorporate additional information, such as relevant prior art or legal citations, into the response strategies.

In some embodiments, the server 204 may be further configured to generate a response Office action template (e.g., an Office action template 302 shown in FIG. 3), which includes placeholders for generating responses and arguments in response to the most recent Office action. The server 204 may also be configured to present the generated responses, annotations, citations, and template to the user on the client device 202. The user may then select and edit response strategies, and the server 204 may generate responses and arguments based on the user's selections and edits.

In some cases, the system may be implemented as a non-transitory computer-readable medium storing instructions that, when executed by a processor, cause the processor to perform operations for generating responses to patent Office actions. The operations may include retrieving an Office action from a patent Office database, analyzing the Office action using an AI module to generate response strategies, displaying the generated response strategies and an Office action response template on a user interface, and generating text for sections of the Office action response based on user selections of the response strategies.

In some embodiments, the user interface may be configured to receive an application number associated with the patent Office action. The server may then load the patent Office action and one or more documents related to the application number. The AI machine may generate response strategies for responding to one or more rejections or objections in the patent Office action. The user interface may then receive generated text affiliated with a response to the one or more rejections or objections in the patent Office action.

Still referring to FIG. 2, in step 246, the server 204 generates the Office action template 302 shown in FIG. 3. The Office action template 302 may be generated based on a standard format for Office action responses, and may include sections for addressing different types of rejections or objections. Each section may include a placeholder that can be replaced with generated text based on user selections of the response strategies.

In step 248 shown in FIG. 2, the server 204 sends the generated response strategies and the Office action response template (such as the Office action template 302 shown in FIG. 3) to the client device 202. The client device 202 may display the response strategies and the template (e.g., the Office action template 302 shown in FIG. 3) on the user interface (e.g., the user interface 300 shown in FIG. 3), allowing the user to review the strategies and select or edit them as desired.

In step 250, the Office action response template (e.g., the Office action template 302 shown in FIG. 3) and the response strategies are presented to the user on the client device 202. The user may interact with the user interface (e.g., the user interface 300 shown in FIG. 3) to select and edit the response strategies, and to generate responses to the Office action based on the selected strategies.

In step 252, the user selects, edits, or further generates response strategies on the client device 202. The user may interact with the user interface (e.g., the user interface 300 shown in FIG. 3) to make the selections and edits. The user may also input additional information or instructions, such as specific arguments or amendments to be included in the responses.

In step 254, the user selects an AI section (e.g., a first AI section placeholder 306 shown in FIG. 3) in the Office action response template (e.g., the Office action template 302 shown in FIG. 3). The AI section (e.g., the first AI section placeholder 306) may correspond to a placeholder in the template (e.g., the Office action template 302) that is designated for replacement with generated text. The user may select the AI section by clicking on it, tapping it, or using other input methods.

Next, in step 256, the user executes an action to the server 204 to generate a portion of the Office action response. The action may be executed by clicking a button, selecting a menu option, or using other input methods. The action may trigger the server 204 to generate text for the selected AI section based on the user's selections and edits of the response strategies. Further, in step 258, based on the AI section executed by the user, the server 204 selects a set of instructions. The set of instructions may include guidelines or rules for generating responses to the rejections and objections. The server 204 may select the set of instructions based on various factors, such as the nature of the rejections and objections, the content of the Office action, and potentially other information related to the patent application.

In step 260, the server 204 sends the set of instructions, selected response strategies, and relevant prior art information to the LLM server 206. The LLM server 206 may use the set of instructions and the provided information to generate text for the selected AI section of the Office action response.

In step 262, the LLM server 206 generates text for the selected AI section of the Office action response. The LLM server 206 may use the set of instructions, the selected response strategies, and the relevant prior art information to generate this text. The generated text may include arguments, amendments, or other responses to the rejections and objections in the Office action.

In step 264, the LLM server 206 sends the generated text to the server 204. The server 204 may receive the generated text and optionally process it further. For example, the server 204 may format the text for display on the user interface 300 shown in FIG. 3, or incorporate it into the Office action template 302, also shown in FIG. 3.

Referring back to FIG. 2, in step 266, the server 204 optionally processes and edits the output from the LLM server 206. The server 204 may perform various operations on the generated text, such as formatting it for display on the user interface 300 shown in FIG. 3, incorporating it into the Office action template 302, or adding additional information or references.

Finally, in step 268 shown in FIG. 2, the server 204 outputs the text to the client device 202 for further editing. The client device 202 may display the text on the user interface 300 shown in FIG. 3, allowing the user to review and edit the text as desired. The user may then finalize the Office action response and submit it to the patent Office.

Referring to FIG. 3, the user interface 300 for managing patent Office action responses is shown. The user interface 300 may be displayed on the client device 202 shown in FIG. 2, such as a personal computer, laptop, tablet, or smartphone. The user interface 300 of FIG. 3 may be part of a software application configured to facilitate the management and response of patent Office actions. The user interface 300 may include various components and features designed to assist a user in generating responses to Office actions.

One component of the user interface 300 is an Office action template 302. The Office action template 302 may be a structured document or form that provides a format for the responses to the Office action. The Office action template 302 may include various sections or fields for entering information related to the Office action and the responses thereto.

At the top of the Office action template 302, there may be auto-populated text 304. The auto-populated text 304 may include details such as the docket number, inventor information, and filing details. The filing details may be automatically populated based on the patent application number or other information associated with the Office action.

In step 246 shown in FIG. 2, the server 204 may generate the Office action template 302 (see FIG. 3) by utilizing a combination of predefined templates and dynamic content generation. The Office action template 302 shown in FIG. 3 may be structured based on standard formats for Office action responses, which may vary depending on the patent Office and type of Office action. The server 204 may select an appropriate base template and then customize it for the specific Office action being addressed.

The auto-populated text 304 may be generated by extracting relevant information from the patent application documents and Office action retrieved in earlier steps. This may include the application number, filing date, inventor names, examiner information, and other bibliographic data. The server 204 shown in FIG. 2 may use natural language processing techniques to identify and extract this information from the retrieved documents.

Referring back to FIG. 3, the AI section placeholders, e.g., a first AI section placeholder 306, a second AI section placeholder 308, a third AI section placeholder 310, and a fourth AI section placeholder 312, may be created based on the analysis of the Office action performed in previous steps. The server 204 shown in FIG. 2 may identify the types of rejections and objections present in the Office action and create corresponding placeholders in the template. The AI placeholders 306, 308, 310, 312 may be labeled according to the type of rejection or section of the response they represent.

In step 248 shown in FIG. 2, the server 204 may send the generated Office action template 302 shown in FIG. 3, including the auto-populated text 304 and AI section placeholders, to the client device 202 in FIG. 2. This transmission may occur over a network connection, such as the internet, using secure protocols to protect the confidentiality of the patent application information. The server 204 may package the template and associated data in a format compatible with the client device's software application.

In step 250 shown in FIG. 2, when the Office action template 302 (see FIG. 3) is received by the client device 202, the user interface 300 shown in FIG. 3 may render and display the template to the user. The auto-populated text 304 may be presented at the top of the template, providing the user with immediate access to key information about the application and Office action. The AI section placeholders may be displayed as interactive elements within the template, allowing the user to easily identify areas where AI-generated content can be inserted.

Referring again to FIG. 3, the user interface 300 may format the Office action template 302 to match the layout and styling of a typical Office action response document. This may include appropriate spacing, font styles, and section headings. The AI section placeholders may be visually distinct, possibly using different colors or icons, to clearly indicate to the user where AI assistance is available.

In some implementations, the user interface 300 may provide tooltips or help text associated with each AI section placeholder, offering guidance on the type of content that can be generated for that section. The interface may also include options for the user to customize the display of the template, such as collapsing or expanding sections, or adjusting the zoom level for easier viewing on different devices.

Below the auto-populated text 304, the Office action template 302 may include several placeholders for generating responses and arguments in response to the Office action. The AI placeholders 306, 308, 310, 312 may correspond to different sections of the Office action response, such as sections addressing rejections under different statutory provisions or sections providing arguments in support of patentability.

For example, the Office action template 302 may include the first AI section placeholder 306 labeled “LISTING OF THE CLAIMS”. This placeholder may be designated for generating a listing of the claims in the patent application. The Office action template 302 may also include the second AI section placeholder 308 labeled “Introduction” for providing introductory remarks. Following this are two rejection sections: the third AI section placeholder 310 for addressing “Rejections under 35 U.S.C. 112”, and the fourth AI section placeholder 312 for addressing “Rejections under 35 U.S.C. 102”. Each of the AI placeholders 306, 308, 310, 312 may be replaced with generated text based on user selections of the response strategies.

Adjacent to the Office action template 302, the user interface 300 may include a second interface 314. The second interface 314 may provide additional features or tools for managing the Office action responses. At the top of the second interface 314, there may be a response strategy tab 316 and a file wrapper tab 318. The response strategy tab 316 may display the generated response strategies, while the file wrapper tab 318 may display various documents related to the patent application.

Below the tabs, the second interface 314 may include sections for displaying patent Office documents 320 and prior art documents 322. The patent Office documents 320 may include various documents related to the patent application, such as pending claims, Office actions, responses to Office actions, and as-filed specifications and drawings. The prior art documents 322 may include relevant prior art documents that may be pertinent to the patent application. The prior art documents 322 may be retrieved from the prior art database 210 (see FIG. 2) and displayed on the second interface 314 for the user's reference.

In some embodiments, the user interface 300 may be configured to receive an application number associated with the patent Office action. The server 204 (see FIG. 2) may then load the patent Office action and one or more documents related to the application number. The AI machine may generate response strategies for responding to one or more rejections or objections in the patent Office action. The user interface 300 may then receive generated text affiliated with a response to the one or more rejections or objections in the patent Office action.

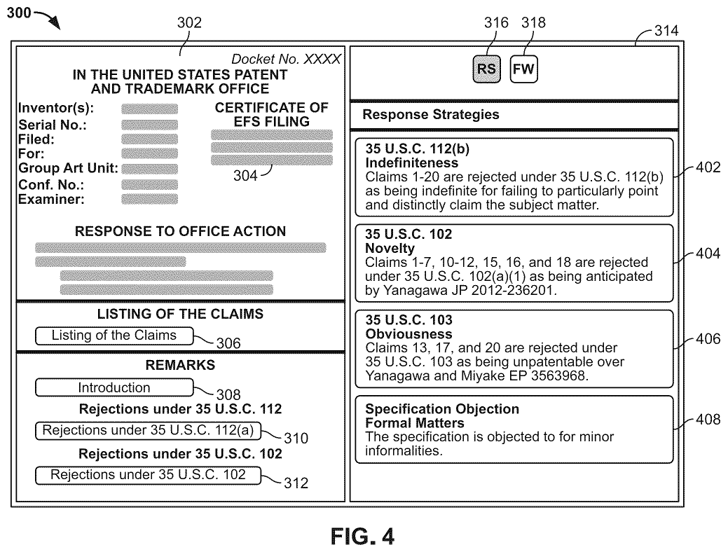

Referring to FIG. 4, the user interface 300 is shown displaying response strategies for different types of rejections and objections in the second interface 314 adjacent to the Office action template 302. The second interface 314 may be configured to display a plurality of response strategies generated by the AI module. The response strategies may be organized into different sections or cards, each addressing a different type of rejection or objection identified in the Office action.

For instance, the second interface 314 may include a first rejection card 402 addressing claims rejected under 35 U.S.C. 112(b), a second rejection card 404 pertaining to claims rejected under 35 U.S.C. 102, a third rejection card 406 relating to claims rejected under 35 U.S.C. 103, and a fourth rejection card 408 addressing formal matters regarding the specification. Each rejection card may display one or more AI-generated response strategies for addressing the corresponding rejection or objection.

In some cases, the AI module may generate the response strategies based on the extracted rejections and objections from the Office action. The AI module may use machine learning models, such as large language models (LLMs), to generate the response strategies. The generated response strategies may include proposed arguments, amendments, or other responses to the rejections and objections.

In some embodiments, the user interface 300 may be configured to display the generated response strategies and the Office action template 302 concurrently. This may allow the user to review the response strategies while drafting the response to the Office action. The user may select a response strategy from the second interface 314 and insert it into the corresponding section of the Office action template 302.

In some aspects, the user interface 300 may also include the file wrapper tab 318 in the second interface 314. The file wrapper tab 318 may display various documents related to the patent application, such as pending claims, Office actions, responses to Office actions, and as-filed specifications and drawings. This may provide the user with additional context or references when drafting the response to the Office action.

In some cases, the server 204 from FIG. 2 may be configured to receive user selections of the response strategies and generate text for sections of the Office action response based on the user selections. The server 204 may communicate with the LLM server 206 to generate this text, which may be displayed on the user interface 300 (see FIG. 3) for further editing by the user.

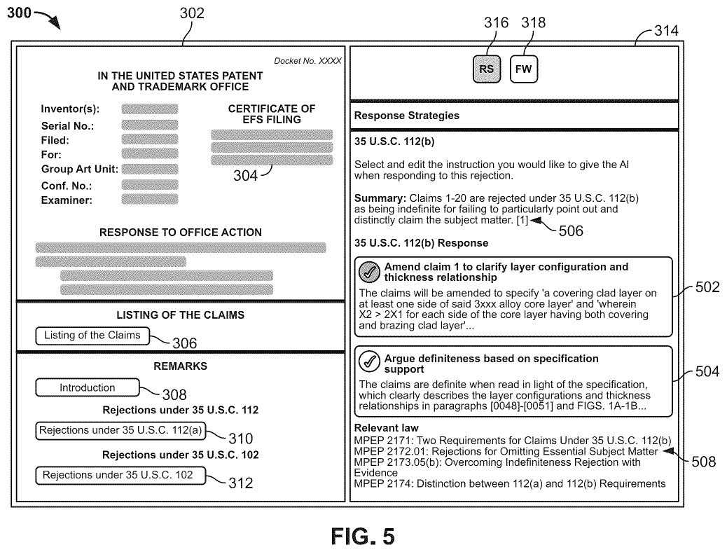

Referring to FIG. 5, the user interface 300 is shown displaying detailed response strategies for a specific rejection type and presenting relevant law citations related to that rejection. The user interface 300 may be configured to display this detailed view when a user clicks into one of the particular rejection cards shown in FIG. 4.

In some cases, the user interface 300 may display the generated response strategies and the Office action template 302 concurrently. This may allow the user to review the response strategies while drafting the response to the Office action. The user may select a response strategy from the second interface 314 and insert it into the corresponding section of the Office action template 302.

In the second interface 314, which may be displayed when a user clicks into one of the particular rejection cards shown in FIG. 4, the user interface 300 may display “Response Strategies” for addressing rejections under 35 U.S.C. 112(b). The interface may present two response strategies: a first response strategy 502 suggesting to amend claim 1 to clarify layer configuration and thickness relationship, and a second response strategy 504 proposing to argue definiteness based on specification support. A document citation 506 may provide an overview of the rejection.

At the bottom of the second interface 314 shown in FIG. 5, relevant law citations 508 may list MPEP sections related to 35 U.S.C. 112(b) requirements and rejections. The law citations 508 may be generated by the AI module and displayed on the user interface 300. The law citations 508 may provide additional context or references for the user when drafting responses to the rejections. The user may select a law citation 508 from the list and insert it into the corresponding section of the Office action template 302. The law citations 508 may be displayed in a dedicated section of the user interface 300, and may be organized or sorted based on various criteria, such as relevance, frequency of citation, or legal authority.

In some embodiments, the user interface 300 may be configured to receive user input when selecting the law citation 508. The server 204 (see FIG. 2) may then generate text for the selected law citation 508 and display it on the user interface 300. The generated text may include a summary or explanation of the law citation 508, which may assist the user in understanding the relevance of the law citation 508 to the rejection.

In some cases, the user interface 300 may be configured to display the generated response strategies and the Office action template 302 concurrently. This may allow the user to review the response strategies while drafting the response to the Office action. The user may select a response strategy from the second interface 314 and insert it into the corresponding section of the Office action template 302.

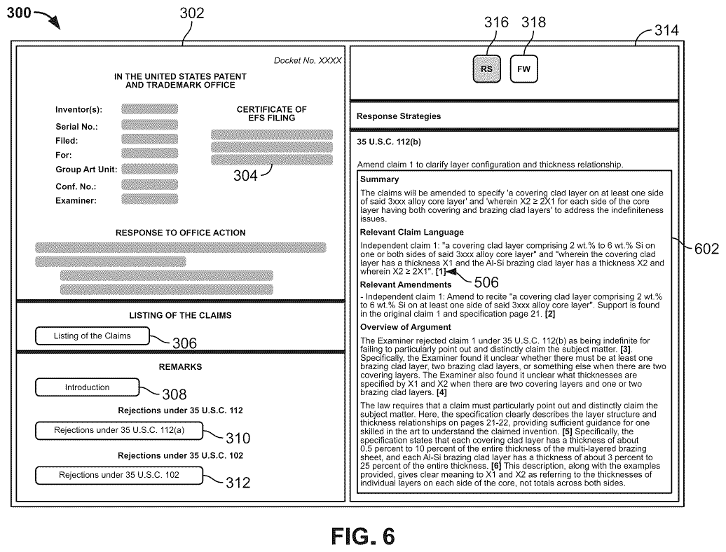

Referring to FIG. 6, the user interface 300 is shown displaying a detailed view of a selected response strategy in the second interface 314 adjacent to the Office action template 302. In some aspects, when a user selects a response strategy from one of the response strategy cards shown in FIG. 5, the user interface 300 may present a detailed view of the selected strategy in the second interface 314, as shown in FIG. 6. This detailed view may include additional information about the strategy, such as a detailed explanation of the strategy, a list of steps or actions to be taken as part of the strategy, or other relevant information.

In the detailed view, the second interface 314 may display the text of the selected response strategy, which may include arguments, amendments, or other responses to a specific rejection or objection in the Office action. The text of the response strategy may be generated by the AI module and may be based on various factors, such as the nature of the rejection or objection, the content of the Office action, and potentially other information related to the patent application.

As shown in FIG. 6, the second interface 314 may also display one or more document citations 506 associated with the selected response strategy. The document citations 506 may provide references to documents, such as prior art documents, the Office action, or other documents in the file wrapper (see FIG. 3), that are relevant to the response strategy. The document citations 506 may be interactive, allowing the user to click on a citation to view the referenced document or to insert the citation into the Office action template 302.

In some embodiments, the user interface 300 may be configured to highlight the referenced document or citation in the Office action template 302 when the user selects the document citation 506 in the second interface 314. This may provide the user with additional context or references when drafting responses to the rejections or objections in the Office action.

In some aspects, the user interface 300 may be configured to receive user input selecting the document citation 506. The server 204 (see FIG. 2) may then generate text for the selected document citation 506 and display it on the user interface 300. The generated text may include a summary or explanation of the document citation 506, which may assist the user in understanding the relevance of the document citation 506 to the rejection or objection.

In some cases, the user interface 300 may be configured to display the generated response strategies and the Office action template 302 concurrently. This may allow the user to review the response strategies while drafting the response to the Office action. The user may select a response strategy from the second interface 314 and insert it into the corresponding section of the Office action template 302.

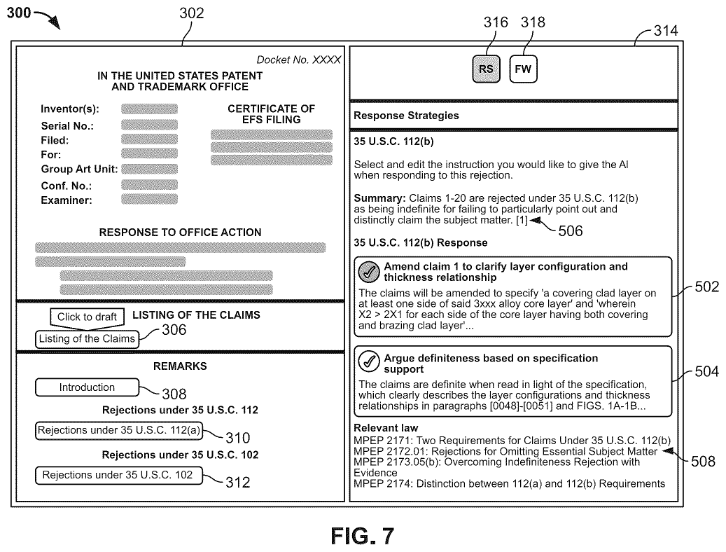

Next, referring to FIG. 7, the user interface 300 is shown displaying the Office action template 302 with the first AI section placeholder 306 in a first state. The first AI section placeholder 306 is labeled “LISTING OF THE CLAIMS” and includes a “Click to draft” button. The “Click to draft” button may be an interactive element of the user interface 300 that allows the user to initiate the generation of text for the corresponding section of the Office action response.

In some aspects, when the user clicks on the “Click to draft” button associated with the first AI section placeholder 306, the client device 202 shown in FIG. 2 may send a signal to the server 204 indicating that the user has selected the first AI section placeholder 306, shown in FIG. 7. The signal may include an identifier for the selected placeholder, such as a placeholder ID or a reference to the section of the Office action response associated with the placeholder.

Upon receiving the signal from the client device 202 in FIG. 2, the server 204 may initiate a process to generate text for the selected first AI section placeholder 306 shown in FIG. 7. This process may involve selecting a set of instructions based on the type of the selected placeholder, the content of the Office action, and potentially other factors. The server 204 in FIG. 2 may then send the set of instructions, along with other relevant information, to the LLM server 206 to generate the text.

With reference to FIGS. 2 and 7, in some cases, the server 204 may receive user input selecting the first AI section placeholder 306. The user input may be received through the user interface 300, and may include a selection of the “Click to draft” button or other input indicating the user's selection of the first AI section placeholder 306. The server 204 may then initiate a process to generate text for the selected first AI section placeholder 306 based on the user's input. This process may involve selecting a set of instructions, generating a prompt, and communicating the prompt to the LLM server 206 to generate the text. The generated text may then be displayed on the user interface 300 for further editing by the user.

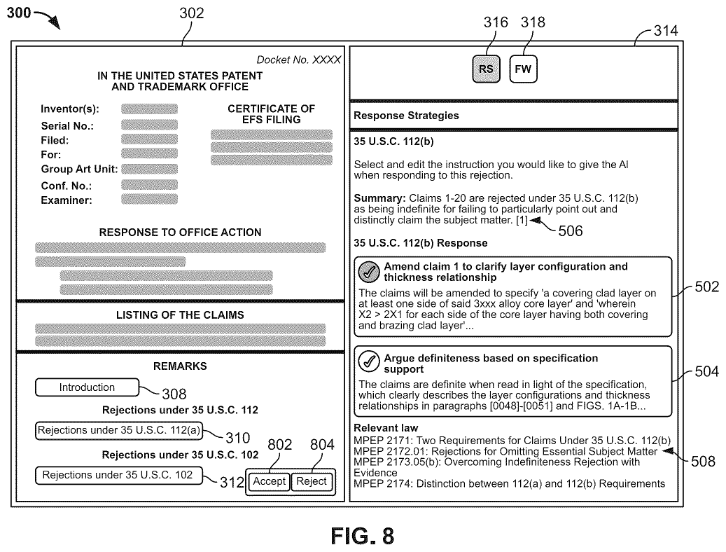

In particular, referring to FIG. 8, the user interface 300 is shown displaying generated text for a section of the Office action response and providing user interaction options for accepting or rejecting the generated content. In some aspects, the user interface 300 may be configured to display generated text for sections of the Office action response based on user selections of the response strategies. The generated text may be displayed in the Office action template 302, replacing the corresponding AI section placeholder 306, 308, 310, or 312 shown in FIGS. 7 and 8.

In some cases, the processor may be configured to incorporate relevant law citations 508 into the generated text for sections of the Office action response. The relevant law citations 508 may be selected from a list of law citations displayed on the second interface 314. The processor may insert the law citations 508 into the generated text at appropriate locations, such as in arguments or responses to rejections that reference the cited laws.

In some embodiments, with respect to FIGS. 2 and 8, the server 204 may transmit the generated text to the client device 202 for display on the user interface 300. The server 204 may send the generated text over a network connection to the client device 202, where it may be displayed in the Office action template 302 on the user interface 300. The generated text may replace the corresponding AI section placeholder 306, 308, 310, or 312 (shown in FIGS. 7 and 8) in the Office action template 302.

In some aspects, as shown in FIG. 8, the user interface 300 may be configured to display the generated text through the user interface 300. The generated text may be displayed in the Office action template 302, replacing the corresponding AI section placeholder 306, 308, 310, or 312, shown in FIGS. 7 and 8. The user interface 300 may also provide user interaction options for accepting or rejecting the generated content. For example, the user interface 300 may include an accept button 802 and a reject button 804 associated with the generated text. The user may click the accept button 802 to accept the generated text and incorporate it into the Office action response, or click the reject button 804 to reject the generated text and request new text to be generated.

Referring to FIG. 8, the user interface 300 is shown displaying generated text for a section of the Office action response and providing user interaction options for accepting or rejecting the generated content. In some aspects, the user interface 300 may be configured to display generated text for sections of the Office action response based on user selections of the response strategies. The generated text may be displayed in the Office action template 302, replacing the corresponding AI section placeholder 306, 308, 310, or 312 shown in FIGS. 7 and 8.

In some cases, the processor may be configured to incorporate relevant law citations 508 into the generated text for sections of the Office action response. The relevant law citations 508 may be selected from a list of law citations displayed on the second interface 314. The processor may insert the law citations 508 into the generated text at appropriate locations, such as in arguments or responses to rejections that reference the cited laws.

In some embodiments, the server 204 shown in FIG. 2 may transmit the generated text to the client device 202 for display on the user interface 300 shown in FIG. 3. The server 204 may send the generated text over a network connection to the client device 202, where it may be displayed in the Office action template 302 on the user interface 300. The generated text may replace the corresponding AI section placeholder 306, 308, 310, or 312 in the Office action template 302 shown in FIGS. 7 and 8.

With reference to FIG. 8, in some aspects, the user interface 300 may be configured to receive user input selecting a law citation 508. The server 204 in FIG. 2 may then generate text for the selected law citation 508 and display it on the user interface 300. The generated text may include a summary or explanation of the law citation 508, which may assist the user in understanding the relevance of the law citation 508 to the rejection or objection.

In some cases, the user interface 300 may be configured to display the generated response strategies and the Office action template 302 concurrently. This may allow the user to review the response strategies while drafting the response to the Office action. The user may select a response strategy from the second interface 314 and insert it into the corresponding section of the Office action template 302.

With continued reference to FIG. 8, once the text is generated and displayed in the Office action template 302, the user interface 300 may provide user interaction options for accepting or rejecting the generated content. For example, the user interface 300 may include an accept button 802 and a reject button 804 associated with the generated text. The user may click the accept button 802 to accept the generated text and incorporate it into the Office action response, or click the reject button 804 to reject the generated text and request new text to be generated. This feature may provide the user with flexibility and control over the content of the Office action response, allowing the user to tailor the response to the specific circumstances of the patent application.

A number of implementations have been described. Nevertheless, it will be understood that various modifications may be made without departing from the spirit and scope of the disclosure. Accordingly, other implementations are within the scope of the following claims.

### INDUSTRIAL APPLICABILITY

The present disclosure is directed disclosure relates to systems and methods for generating responses to patent Office actions, and more particularly to an AI-assisted system and method for analyzing Office actions, generating response strategies, and drafting Office action responses. Numerous modifications to the present invention will be apparent to those skilled in the art in view of the foregoing description. Accordingly, this description is to be construed as illustrative only and is presented for the purpose of enabling those skilled in the art to make and use the invention. The exclusive rights to all modifications which come within the scope of the appended claims are reserved.

We claim:

1. A system for generating responses to patent Office actions, comprising:
a server configured to retrieve an Office action from a patent Office database;
an artificial intelligence (AI) module configured to analyze the Office action and generate response strategies;
a user interface configured to display the generated response strategies and an Office action response template; and
a processor configured to generate text for sections of the Office action response template based on user selections of the response strategies.

2. The system of claim 1, wherein the AI module is further configured to extract rejections and objections from the Office action.

3. The system of claim 2, wherein the AI module is configured to generate the response strategies based on the extracted rejections and objections.

4. The system of claim 1, further comprising a prior art database, wherein the server is configured to retrieve prior art documents cited in the Office action from the prior art database.

5. The system of claim 4, wherein the AI module is configured to analyze the retrieved prior art documents and incorporate relevant information into the generated response strategies.

6. The system of claim 1, wherein the user interface is configured to display relevant law citations related to the rejections in the Office action.

7. The system of claim 6, wherein the processor is configured to incorporate the relevant law citations into the generated text for sections of the Office action response.

8. A method for generating responses to patent Office actions, comprising:
retrieving an Office action from a patent Office database;
analyzing the Office action using an artificial intelligence (AI) module to generate response strategies;
displaying the generated response strategies and an Office action response template on a user interface; and
generating text for sections of the Office action response based on user selections of the response strategies.

9. The method of claim 8, further comprising extracting rejections and objections from the Office action using the AI module.

10. The method of claim 9, wherein generating the response strategies is based on the extracted rejections and objections.

11. The method of claim 8, further comprising retrieving prior art documents cited in the Office action from a prior art database.

12. The method of claim 11, further comprising analyzing the retrieved prior art documents using the AI module and incorporating relevant information into the generated response strategies.

13. The method of claim 8, further comprising displaying relevant law citations related to the rejections in the Office action on the user interface.

14. The method of claim 13, wherein generating text for sections of the Office action response includes incorporating the relevant law citations into the generated text.

15. A non-transitory computer-readable medium storing instructions that, when executed by a processor, cause the processor to perform operations for generating responses to patent Office actions, the operations comprising:
retrieving an Office action from a patent Office database;
analyzing the Office action using an artificial intelligence (AI) module to generate response strategies;
displaying the generated response strategies and an Office action response template on a user interface; and
generating text for sections of the Office action response based on user selections of the response strategies.

16. The non-transitory computer-readable medium of claim 15, wherein the operations further comprise extracting rejections and objections from the Office action using the AI module.

17. The non-transitory computer-readable medium of claim 16, wherein generating the response strategies is based on the extracted rejections and objections.

18. The non-transitory computer-readable medium of claim 15, wherein the operations further comprise retrieving prior art documents cited in the Office action from a prior art database.

19. The non-transitory computer-readable medium of claim 18, wherein the operations further comprise analyzing the retrieved prior art documents using the AI module and incorporating relevant information into the generated response strategies.

20. The non-transitory computer-readable medium of claim 19, wherein the operations further comprise displaying relevant law citations related to the rejections in the Office action on the user interface, and wherein generating text for sections of the Office action response includes incorporating the relevant law citations into the generated text.

21. A method for improving an efficiency and a performance of a system for drafting a response to a patent Office action by utilizing an artificial intelligence (AI) machine, comprising:
inputting, through a user interface, an application number associated with the patent Office action;
loading, through a server, the patent Office action and one or more documents related to the application number;
generating, using an AI machine, response strategies for responding to one or more rejections or objections in the patent Office action; and
receiving, through the user interface, generated text affiliated with a response to the one or more rejections or objections in the patent Office action.

22. A system with improved efficiency and performance in drafting a response to a patent Office action by utilizing an artificial intelligence (AI) machine, comprising:
a client device configured to display a user interface;
a server communicatively coupled to the client device; and
a large language model (LLM) server communicatively coupled to the server,
wherein the server is configured to:
receive a placeholder identified from the client device;
generate a prompt;
communicate the prompt to the LLM server;
received generated text from the LLM server; and
transmit the generated text to the client device and display the generated text on the user interface.

23. A non-transitory computer-readable medium storing instructions that, when executed by a processor, cause the processor to perform operations for improving an efficiency and a performance of a system for drafting a response to an Office action, the operations comprising:
displaying one or more placeholders associated with sections of an Office action response on a user interface;
receiving user input selecting a placeholder;
transmitting a request to draft a selected section, the request including a placeholder identifier;
receiving generated text for the selected section; and
displaying the generated text through the user interface.
